(19) United States
(12) Patent Application Publication
(10) Pub. No.: US 2016/0149392 A1
(43) Pub. Date: May 26, 2016

(54) PROTECTION CIRCUIT

(71) Applicant: HON HAI PRECISION INDUSTRY CO., LTD., New Taipei (TW)

(72) Inventor: HSIANG-PIN TSENG, New Taipei (TW)

(21) Appl. No.: 14/587,611

(22) Filed: Dec. 31, 2014

(30) Foreign Application Priority Data
Nov. 25, 2014 (TW) 103140720

(51) Int. Cl. H02H 3/20

(52) U.S. Cl. CPC H02H 3/20

(57) ABSTRACT

A protection circuit includes a first and a second input terminal, an output terminal, a first and a second switch circuit. The first switch circuit includes a first, a second, and a third coupling terminal. The second switch circuit includes a fourth coupling terminal, a fifth coupling terminal, and a sixth coupling terminal. The first coupling terminal and the fourth coupling terminal connect to the first input terminal. The second coupling terminal connects to the second input terminal. The third coupling terminal connects to the fifth coupling terminal. The sixth coupling terminal connects to the output terminal. When the first input terminal receives a high level signal and the second input terminal is not coupled, the first switch circuit is switched on, the fifth coupling terminal receives a low level signal, the second switch circuit is switched off, and the output terminal outputs the low level signal.

### CROSS-REFERENCE TO RELATED APPLICATIONS

This application claims priority to Taiwanese Patent Application No. 103140720 filed on Nov. 25, 2014, the contents of which are incorporated by reference herein.

### FIELD

The subject matter herein generally relates to a protection circuit of an electronic device.

### BACKGROUND

When a positive pin of the battery is coupled to an electronic device prior to a negative pin, a circuit of the electronic device will receive a high level voltage instantly. The electronic devices will be damaged.

### BRIEF DESCRIPTION OF THE DRAWINGS

Implementations of the present technology will now be described, by way of example only, with reference to the attached figures.

FIG. 1 is a block diagram of a protection circuit in accordance with an embodiment.

FIG. 2 is a detailed circuit diagram of the protection circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is described in relation to a protection circuit.

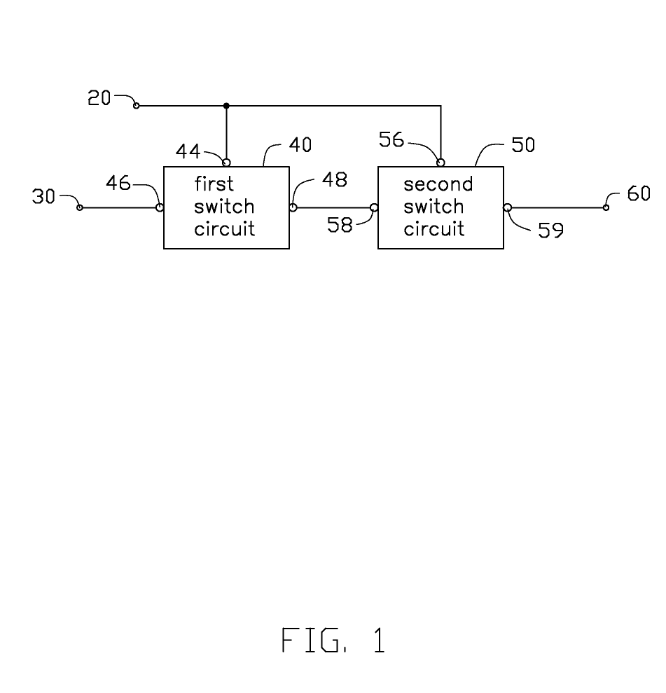

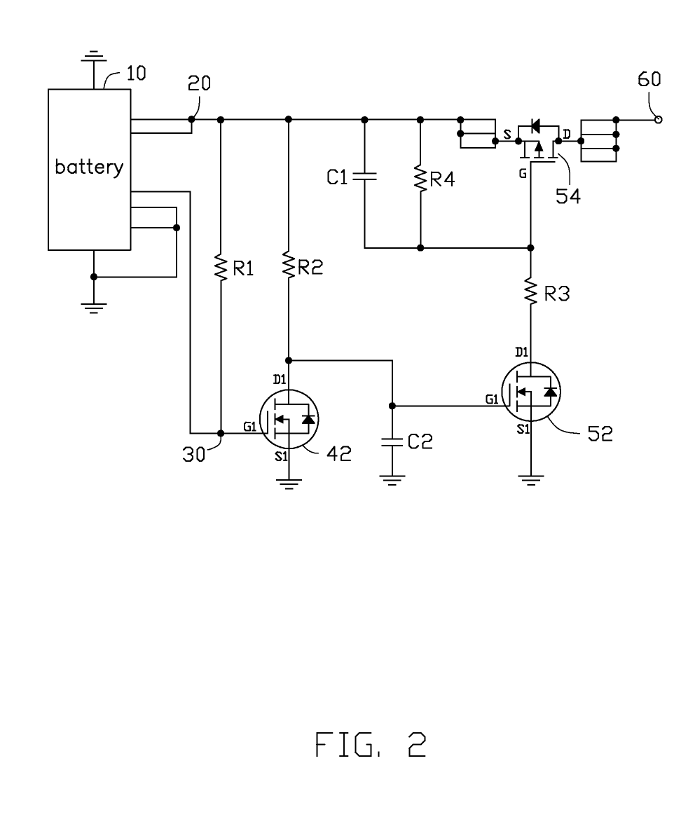

FIGS. 1 and 2 illustrate one embodiment of a protection circuit to prevent an electronic device from being damaged. The protection circuit includes a first input terminal 20, a second input terminal 30, a first switch circuit 40, a second switch circuit 50, and an output terminal 60. The first switch circuit 40 is coupled to the first input terminal 20 and the second input terminal 30. The second switch circuit 50 is coupled to the first switch circuit 40 and the first input terminal 20. The output terminal 60 is coupled to the second switch circuit 50.

The first input terminal 20 is coupled to a positive terminal of a battery 10. The second input terminal 30 is coupled to a negative terminal of the battery 10. The negative terminal of the battery 10 is grounded. The first switch circuit 40 includes a resistor R1, a first transistor 42, a first coupling terminal 44, a second coupling terminal 46, a third coupling terminal 48. The resistor R1 is coupled to the first input terminal 20 via the first coupling terminal 44. The resistor R1 is coupled to the second input terminal 30 via the second coupling terminal 46. The first transistor 42 is coupled to the second input terminal 30 via the second coupling terminal 46. In at least one embodiment, a resistance of the resistor R1 is about 470 KΩ, and the first transistor 42 can be an N-typed field-effect transistor. A grid terminal of the first transistor 42 is coupled to the resistor R1. A source terminal of the first transistor 42 is grounded.

The second switch circuit 50 includes a resistor R2, a resistor R3, a resistor R4, a capacitor C1, capacitor C2, a second transistor 52, a third transistor 54, a fourth coupling terminal 56, a fifth coupling terminal 58, and a sixth coupling terminal 59. The resistor R2 is coupled to the first input terminal 20 via the fourth coupling terminal 56. In at least one embodiment, the second transistor 52 is an N typed field-effect transistor, and the third transistor 54 is a P typed field-effect transistor. The resistor R2 is coupled to a drain terminal of the first transistor 42. The drain terminal of the first transistor 42 is grounded via the capacitor C2. A grid terminal of the second transistor 52 is coupled to the drain terminal of the first transistor 42 via the fifth coupling terminal 58. A source terminal of the second transistor 52 is grounded. A drain terminal of the second transistor 52 is coupled to a grid terminal of the third transistor 54 via the resistor R3. The resistor R4 is coupled to the first input terminal 20 and the grid terminal of the third transistor 54. The capacitor C1 is coupled to the first input terminal 20 and the grid terminal of the third transistor 54. A source terminal of the third transistor 54 is coupled to the first input terminal 20 via the fourth coupling terminal 56. A drain terminal of the third transistor 54 is coupled to the output terminal 60 via the sixth coupling terminal 59. The output terminal 60 is coupled to an electronic device. In at least one embodiment, a resistance of the resistor R2 is about 330 KΩ, a resistance of the resistor R3 is about 220 KΩ, a resistance of the resistor R4 is about 220 KΩ, a capacitance of the capacitor C1 is about 100 nF, and a capacitance of the capacitor C2 is about 10 nF.

In use, when the negative terminal of the battery 10 is coupled to the protection circuit before the positive terminal of the battery 10 is coupled to the protection circuit, the first input terminal 20 receives a high level signal. The battery 10 includes an internal resistor. A resistance of the internal resistor is smaller than the resistor R1, thereby the grid terminal of the first transistor 42 receives a low level signal. The first transistor 42 is switched off. The grid terminal of the second transistor 52 receives a high level signal. The second transistor 52 is switched on. The grid terminal of the third transistor 54 receives a low level signal, and the source terminal of the third transistor 54 receives a high level signal. The third transistor 54 is P-typed field-effect transistor. The third transistor 54 is switched on. The output terminal 60 outputs a high level signal to supply to components in the electronic device.

When the positive terminal of the battery 10 is coupled to the protection circuit and the negative terminal of the battery 10 is not coupled. The first input terminal 20 receives a high level signal, and the second input terminal 30 is switched off. The grid terminal of the first transistor 42 receives a high level signal and the first transistor 42 is switched on. The source terminal of the first transistor 42 is grounded, thereby the drain terminal of the first transistor 42 receives a low level signal. The second transistor 52 is switched off. The grid terminal of the third transistor 54 receives a high level signal, and the source terminal of the third transistor 54 receives a high level signal. The third transistor 54 is P-typed field-effect transistor. The third transistor 54 is switched off. The output terminal 60 outputs a low level signal.

The embodiments shown and described above are only examples. Many details are often found in the art such as the other features of a protection circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A protection circuit comprising:
a first input terminal;
a second input terminal;
an output terminal;
a first switch circuit comprising a first coupling terminal coupled to the first input terminal, a second coupling terminal coupled to the second input terminal, and a third coupling terminal; and
a second switch circuit comprising a fourth coupling terminal coupled to the first input terminal, a fifth coupling terminal coupled to the third coupling terminal, and a sixth coupling terminal coupled to the output terminal;
wherein when the first input terminal receives a high level signal and the second input terminal is not coupled, the first switch circuit is switched on, the fifth coupling terminal receives a low level signal, the second switch circuit is switched off, the output terminal outputs a low level signal.

2. The protection circuit of claim 1, wherein when the first input terminal receives a high level signal and the second input terminal is grounded, the first switch circuit is switched off, the fifth coupling terminal receives a high level signal, the second switch circuit is switched on, and the output terminal outputs a high level signal.

3. The protection circuit of claim 2, wherein the first switch circuit comprises a first transistor, when the first input terminal receives a high level signal and the second input terminal is grounded, the second coupling terminal receives a low level signal, and the first transistor is switched off.

4. The protection circuit of claim 3, wherein a grid terminal of the first transistor is coupled to the second input terminal, a drain terminal of the first transistor is coupled to the second switch circuit, and a source terminal of the first transistor is grounded.

5. The protection circuit of claim 3, wherein the second switch circuit comprises a second transistor and a third transistor, a grid terminal of the second transistor is coupled to the drain terminal of the first transistor, a drain terminal of the second transistor is coupled to a grid terminal of the third transistor, a source terminal of the second transistor is grounded, and when the first transistor is switched off, the second transistor and the third transistor are switched on.

6. The protection circuit of claim 5, wherein a source terminal of the third transistor is coupled to the first input terminal, and a drain terminal of the third transistor is coupled to the output terminal.

7. The protection circuit of claim 5, wherein the second switch circuit further comprises a resistor, and the resistor is coupled to the drain terminal of the second transistor and the grid terminal of the third transistor.

8. The protection circuit of claim 5, wherein the second switch circuit further comprises a resistor, and the resistor is coupled to the first input terminal and the grid terminal of the third transistor.

9. The protection circuit of claim 5, wherein the first transistor and the second transistor are N-typed field-effect transistors, and the third transistor is a P-typed field-effect transistor.

10. A protection circuit comprising:
a first input terminal;
a second input terminal;
an output terminal;
a first switch circuit comprising a first transistor, and the first transistor coupled to the first input terminal and the second input terminal; and
a second switch circuit comprising a second transistor and a third transistor, the second transistor coupled to the first transistor and the third transistor, and the third transistor coupled to the first input terminal and the output terminal;
wherein when the first input terminal receives a high level signal and the second input terminal is not coupled, the first transistor is switched on, the second transistor and a third transistor are switched off, the output terminal outputs a low level signal.

11. The protection circuit of claim 10, wherein when the first input terminal receives a high level signal and the second input terminal is grounded, the first transistor is switched off, the second transistor and a third transistor are switched on, and the output terminal outputs a low high signal.

12. The protection circuit of claim 10, wherein the first transistor, the second transistor, and the third transistor are three field-effect transistors.

13. The protection circuit of claim 12, wherein the first transistor and the second transistor are N-typed field-effect transistors, and the third transistor is P-typed field-effect transistor.

14. The protection circuit of claim 12, wherein a grid terminal of the first transistor is coupled to the second input terminal, a drain terminal of the first transistor is coupled to the second switch circuit, and a source terminal of the first transistor is grounded.

15. The protection circuit of claim 12, wherein a grid terminal of the second transistor is coupled to the drain terminal of the first transistor, a drain terminal of the second transistor is coupled to a grid terminal of the third transistor, a source terminal of the second transistor is grounded, and when the first transistor is switched off, the second transistor and the third transistor are switched on.

16. The protection circuit of claim 12, wherein a source terminal of the third transistor is coupled to the first input terminal, and a drain terminal of the third transistor is coupled to the output terminal.

17. The protection circuit of claim 12, wherein the second switch circuit further comprises a resistor, and the resistor is coupled to the drain terminal of the second transistor and the grid terminal of the third transistor.

18. The protection circuit of claim 12, wherein the second switch circuit further comprises a resistor, and the resistor is coupled to the first input terminal and the grid terminal of the third transistor.
